(19) United States
(12) Patent Application Publication
(10) Pub. No.: US 2025/0132321 A1
(43) Pub. Date: Apr. 24, 2025

(54) SILICON COMPOSITE ANODE MATERIAL WITH CONTROLLED PARTICLE SIZE DISTRIBUTION, MANUFACTURING METHOD THEREOF, AND LITHIUM ION BATTERY CONTAINING THE SAME

(71) Applicant: INDUSTRY-ACADEMIC COOPERATION FOUNDATION GYEONGSANG NATIONAL UNIVERSITY, Jinju-si (KR)

(72) Inventors: Jae Kyung Sung, Jinju-si (KR); Dong Hui Kim, Changwon-si (KR); Ju Eun Kim, Yangsan-si (KR)

(73) Assignee: INDUSTRY-ACADEMIC COOPERATION FOUNDATION GYEONGSANG NATIONAL UNIVERSITY, Jinju-si (KR)

(21) Appl. No.: 18/925,066

(22) Filed: Oct. 24, 2024

(30) Foreign Application Priority Data
Oct. 24, 2023 (KR) 10-2023-0142755

(51) Int. Cl. H01M 4/38; H01M 4/02; H01M 4/04; H01M 4/36; H01M 4/583; H01M 10/0525

(52) U.S. Cl. CPC H01M 4/386; H01M 4/0421; H01M 4/366; H01M 4/583; H01M 10/0525; H01M 2004/021

(57) ABSTRACT

The present invention relates to a silicon composite anode material with controlled particle size distribution, a manufacturing method thereof, and a lithium-ion battery containing the same. More specifically, the present invention relates to a silicon composite anode material with controlled particle size distribution, which exhibits stress relaxation of each particle through distribution of various particle sizes and thus prevents mechanical destruction even under a high-pressure condition during a calendering process, a manufacturing method thereof, and a lithium-ion battery containing the same. The silicon composite anode material comprises a graphite mixture; a silicon nanolayer coated on the graphite mixture; and a carbon coating layer coated on the silicon nanolayer.

### CROSS REFERENCE TO RELATED APPLICATION

This application claims priority to Korean Patent Application No. 10-2023-0142755 (filed on Oct. 24, 2023), which is hereby incorporated by reference in its entirety.

### BACKGROUND

The present invention relates to a silicon composite anode material with controlled particle size distribution, a manufacturing method thereof, and a lithium-ion battery containing the same. More specifically, the present invention relates to a silicon composite anode material with controlled particle size distribution, which exhibits stress relaxation of each particle through distribution of various particle sizes and thus prevents mechanical destruction even under a high-pressure condition during a calendering process, a manufacturing method thereof, and a lithium-ion battery containing the same.

In the next-generation lithium-ion battery systems, it is attempted to use silicon anode materials having a theoretical capacity of 3579 mAh/g, which is about 10 times higher than that of existing graphite. However, the silicon anode materials generate a breakage phenomenon due to high expansion and contraction in volume during charging and discharging, compared with graphite. According thereto, decomposition reaction with electrolyte is accelerated, and a thick surface film is formed, and this hinders movement of lithium ions and reduces the lifespan.

In addition, although silicon materials used in the negative electrode of a battery of electric vehicles is an SiOₓ family, which are micron-sized particles contained in less than 5%, as the initial efficiency of the used materials is relatively as low as around 80's, there is a problem in that energy density of the battery is lowered.

As the initial efficiency of the silicon materials is less than 86%, which is lower than 94% of graphite, there is a limit of lowering the efficiency of use. In addition, the larger the silicon particles, the efficiency of the silicon materials is lowered, and as the breakage phenomenon generated by expansion and contraction of the volume accelerates, it leads to problems such as rapid reduction of lifespan and generation of gas.

To solve the problems described above, various nanoengineering strategies including design of porous structures and control of particle sizes have been explored using relaxed stress of expanded silicon to prevent serious mechanical failures, but the low tap density invites dramatic loss of volumetric capacity.

In this regard, an anode material that exhibits excellent electrochemical performance, including a micro-sized silicon composite having a high tap density and many pores that accommodate huge volumetric expansion of silicon, is developed. However, the anode material also generates mechanical destruction due to high pressure applied to the particles during the calendering process, and this results in electrical contact loss of particles and generation of additional by-products and unstable solid films during charge and discharge.

Due to the problems as described above, it needs to provide a silicon composite anode material and a manufacturing method thereof, which can prevent loss of volumetric capacity and exhibit high initial efficiency as the anode material including silicon is not broken even under a high-pressure condition during a calendering process and exhibits a high tap density.

### SUMMARY

Therefore, the present invention has been made in view of the above problems, and it is an object of the present invention to provide a silicon composite anode material, a manufacturing method thereof, and a lithium-ion battery containing the same, which can prevent loss of volumetric capacity and exhibit high initial efficiency as the anode material is not broken even under a high-pressure condition during a calendering process and exhibits a high tap density.

In addition, another object of the present invention is to provide a high-density silicon composite anode material that is not broken by controlling distribution of micro silicon composite particle sizes, and a manufacturing method thereof.

The technical problems to be solved by the present invention are not limited to the technical problems mentioned above, and unmentioned other technical problems will be clearly understood by those skilled in the art from the description of the present invention.

To accomplish the above objects, there is provided a silicon composite anode material with controlled particle size distribution, a manufacturing method thereof, and a lithium-ion battery containing the same.

The present invention relates to a silicon composite anode material with controlled particle size distribution, the silicon composite anode material comprising: a graphite mixture; a silicon nanolayer coated on the graphite mixture; and a carbon coating layer coated on the silicon nanolayer, wherein the silicon composite anode material has a multi-size distribution.

In the present invention, the silicon nanolayer contains particles having a size of 2 nm to 2 μm.

In the present invention, the silicon composite anode material contains pores having a size of 2 nm to 10 μm.

In the present invention, the silicon composite anode material contains particles having a size of 0.5 to 50 μm.

In the present invention, the silicon composite anode material has particle size distributions such as D₁₀ of 1 to 7 μm, D₅₀ of 10 to 20 μm, and D₉₀ of 25 to 35 μm.

In the present invention, the silicon composite anode material is a mixture of a first silicon composite anode material and a second silicon composite anode material.

In the present invention, in the first silicon composite anode material, D₁₀ is 1 to 3 μm, D₅₀ is 2 to 4 μm, and D₉₀ is 3 to 5 μm.

In the present invention, in the second silicon composite anode material, D₁₀ is 5 to 7 μm, D₅₀ is 13 to 15 μm, and D₉₀ is 30 to 35 μm.

In the present invention, the silicon composite is a mixture of the first silicon composite anode material and the second silicon composite anode material at a ratio of 1:0.5 to 1:1.5.

The present invention relates to a method of manufacturing a silicon composite anode material with controlled particle size distribution, the method comprising the steps of: forming a graphite mixture by mixing graphite particles of different sizes; forming a silicon nanolayer by injecting silane (SiH₄) gas into the graphite mixture; and forming a carbon coating layer by injecting ethylene gas into the graphite layer on which the silicon nanolayer is formed.

In the present invention, the step of forming a graphite mixture is a process of mixing graphite particles having average particle sizes of 7 to 9 μm, 9 to 11 μm, 17 to 22 μm, and 28 to 32 μm at a mass ratio of 10:35 to 45:35 or 45:5 to 15.

In the present invention, the step of forming the silicon nanolayer is a process of injecting silane gas at a speed of 30 to 70 sccm for 50 to 90 minutes at a temperature of 430 to 530° C.

In the present invention, the step of forming a carbon coating layer is a process of injecting ethylene gas at a speed of 80 to 120 sccm for 10 to 30 minutes at a temperature of 850 to 950° C.

In the present invention, the silicon composite anode material manufactured according to the manufacturing method is a mixture of particles of a first silicon composite anode material and a second silicon composite anode material.

In the present invention, in the first silicon composite anode material, D₁₀ is 1 to 3 μm, D₅₀ is 2 to 4 μm, and Doo is 3 to 5 μm.

In the present invention, in the second silicon composite anode material, D₁₀ is 5 to 7 μm, D₅₀ is 13 to 15 μm, and D₉₀ is 30 to 35 μm.

The present invention relates to a lithium-ion battery containing the silicon composite anode material.

In the present invention, the lithium-ion battery exhibits an initial specific capacity of 500 mAh/g or more and an initial coulombic efficiency of 92 to 98%.

In the present invention, the lithium-ion battery exhibits an electrode expansion rate of 30 to 40% in the first cycle.

In the present invention, the lithium-ion battery exhibits a capacity retention ratio of 95 to 99.5% for 50 cycles.

The present invention relates to an all-solid-state battery including the silicon composite anode material.

By the means of solving the above problem, the present invention may provide a silicon composite anode material, a manufacturing method thereof, and a lithium-ion battery containing the same, which can prevent loss of volumetric capacity and exhibit high initial efficiency as the anode material is not broken even under a high-pressure condition during a calendering process and exhibits a high tap density.

In addition, the present invention may provide a high-density silicon composite anode material that is not broken by controlling distribution of micro silicon composite particle sizes, and a manufacturing method thereof.

In addition, the present invention may provide a lithium-ion battery containing a silicon composite anode material, which exhibits excellent electrochemical performances such as high initial specific capacity, low electrode expansion rate, excellent cycling stability, and the like by preserving morphological integrity and securing a void space under a high pressure.

In addition, the present invention may provide a silicon composite anode material and a manufacturing method thereof, which can implement a high-energy lithium-ion battery on the basis of a systematic simulation including calculation of a packing ratio relying on distribution of various particle sizes and stress relaxation of each particle.

The effects of the present invention are not limited to the effects mentioned above, and unmentioned other effects will be clearly understood by those skilled in the art from the description of the claims.

### BRIEF DESCRIPTION OF THE DRAWINGS

FIG. 1 is a view showing (a) a three-dimensional graph of the correlation between volumetric energy density and electrode/cell design factors and (b) each operation according to mixing and composing strategies and changes in electrode thickness according to the present invention.

FIG. 2 is a view showing the morphological and electrochemical behaviors of (a) SiG and (b) WD-SiG after a calendering process according to the present invention.

FIG. 3 is a view showing a process of manufacturing a silicon composite anode material according to the present invention.

FIG. 4 is a view showing (a) a DEM simulation result graph related to the packing density according to the mixing ratio of particles of various sizes and (b) a statistical analysis result of the changes in the diameter of SiG and WD-SiG according to the present invention.

FIG. 5 is a view showing a result of SEM measurement on WD-SiG according to the present invention.

FIG. 6 is a view showing a result of TEM measurement on WD-SiG cross-section according to the present invention.

FIG. 7 is a view showing the compressive stress of each particle at an electrode density of 1.75 gcc⁻¹ of (a) SiG and (b) WD-SiG as a result of DEM simulation related to the change in the stress of particles within the electrode during a calendering process according to the present invention.

FIG. 8 is a view showing the accumulated compressive force at different electrode densities of (a) 1.3 gcc⁻¹ and (b) 1.75 gcc⁻¹ as a result of DEM simulation related to the change in the stress of particles within the electrode during a calendering process according to the present invention.

FIG. 9 is a view showing (a) pellet densities of SiG and WD-SiG according to various pressures in a range of 3.84 to 4.80 ton/cm², and photographs of pellets of the WD-SiG, and (b) a result of measuring the pellet height and spring back after pressing according to the present invention.

FIG. 10 is a view showing SEM images of the cross-sections of (a) SiG and (d) WD-SiG, cross-sectional and plan views (b) and (e) of SiG in backscatter electron mode where Si can be clearly observed in white, and cross-sectional and plan views (g) and (h) of WD-SiG according to the present invention.

FIG. 11 is a view showing the voltage profile of the first cycle and the dQ/dV plot during lithiation at different electrode densities of 1.0, 1.6, and 1.8 gcc⁻¹ of (a) SiG and (b) WD-SiG according to the present invention.

FIG. 12 is a view showing the discharge specific capacities and initial CEs of SiG and WD-SiG at various electrode densities in a range of 1.0 to 1.8 gcc⁻¹ according to the present invention.

FIG. 13 is a view showing the cycling performance including reversible capacity and cycling CE of half cells in a potential range of 0.005 to 1.0 V for 50 cycles at different electrode densities of 1.0, 1.6 and 1.8 gcc⁻¹ of (a) SiG and (b) WD-SiG according to the present invention.

FIG. 14 is a view showing (a) a graph comparing the expansion rate of a WD-SiG electrode in a lithiation state at various electrode densities of a range between 1.0 and 1.8 gcc⁻¹ and (b) the electrode expansion rates of SiG and WD-SiG according to the present invention.

FIG. 15 is a view showing the discharge capacity of 150 cycles in a potential range of 2.7 to 4.2 V and a discharge rate of 1 C according to the present invention.

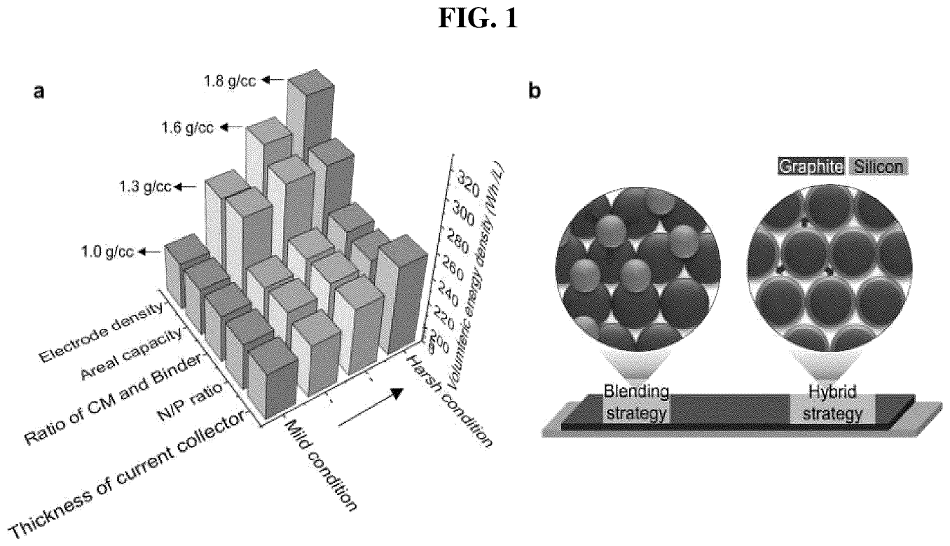

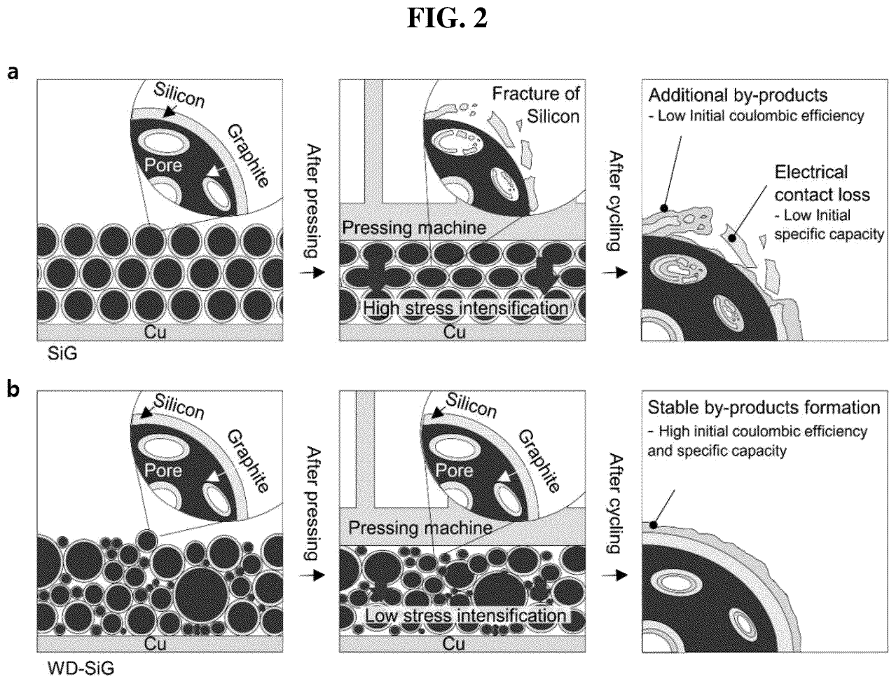

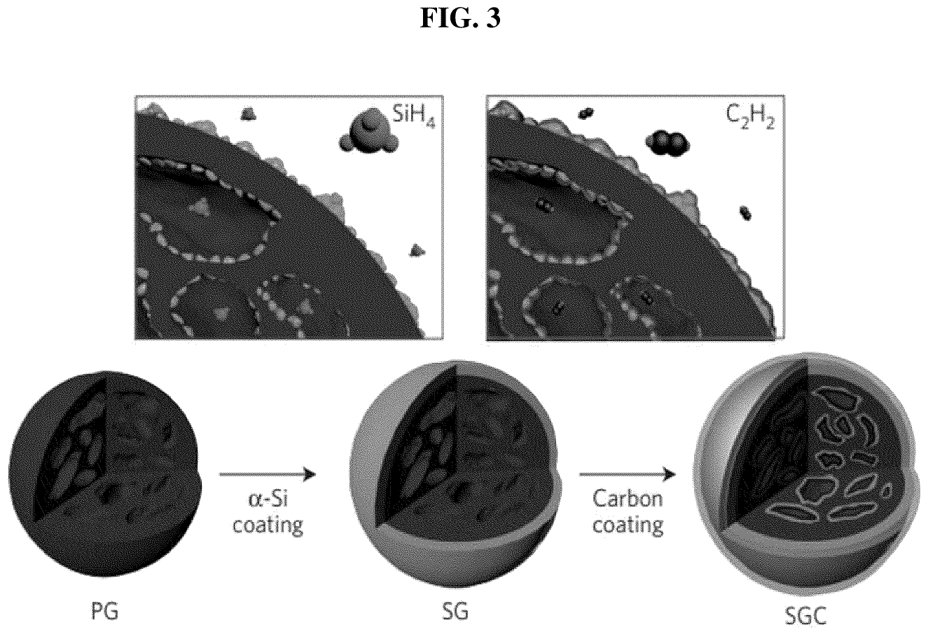

### DETAILED DESCRIPTION

The terms used in this specification are selected from the most widely used general terms as much as possible while considering the functions in the present invention, but they may vary according to the intention of engineers working in the field, precedents, advent of new technologies, or the like. In addition, in specific cases, there are terms arbitrarily selected by the applicant, and in this case, the meanings thereof will be described in detail in the corresponding description of the invention. Therefore, the terms used in the present invention should be defined based on the meanings that the terms have and the overall details of the present invention, rather than simply defined by the names of the terms.

Unless otherwise defined, all terms used herein, including technical or scientific terms, have the same meaning as commonly understood by those skilled in the art. Terms defined in commonly used dictionaries should be interpreted as having a meaning consistent with the meaning they have in the context of related techniques, and will not be interpreted in an ideal or excessively formal sense unless explicitly defined in this application.

The numerical ranges include the numerical values defined in the range described above. All maximum numerical limitations given throughout this specification include all lower numerical limitations in the same manner as low numerical limitations are clearly specified. All minimum numerical limitations given throughout this specification include all higher numerical limitations in the same manner as high numerical limitations are clearly specified. All numerical limitations given throughout this specification include all better numerical ranges within a wider numerical range in the same manner as narrower numerical limitation are clearly specified.

Silicon Composite Anode Material with Controlled Particle Size Distribution

The present invention relates to a silicon composite anode material with controlled particle size distribution.

The present invention relates to a silicon composite anode material with controlled particle size distribution, and the silicon composite anode material comprises: a graphite mixture; a silicon nanolayer coated on the graphite mixture; and a carbon coating layer coated on the silicon nanolayer, and the silicon composite anode material has a multi-size distribution.

The silicon composite anode material may be an anode material manufactured through graphite with a wide particle size distribution to have a high packing density by simply mixing graphite of various sizes based on the result of DEM simulation. The particle size distribution may be a new particle size distribution having low stress intensification and high packing density under a high pressure generated in the calendering process for high electrode density.

In addition, as the morphological integrity of the silicon layer is maintained during the calendering process through the multi-size distribution, porosity is preserved, and SEI may be stably formed in the anode during cycling.

The carbon coating layer is a solid surface coating having high mechanical characteristics for preventing damage to the silicon-based anode, and may be implementing high electrode density without negatively affecting the electrode material and battery performance.

In the present invention, the silicon nanolayer may contain particles having a size of 2 nm to 2 μm.

In the present invention, the silicon composite anode material may contain pores having a size of 2 nm to 10 μm.

In the present invention, the silicon composite anode material may contain particles having a size of 0.5 to 50 μm.

In the present invention, the silicon composite anode material may contain silicon particles having a size of 2 nm to 2 μm.

In the present invention, the silicon composite anode material may have particle size distributions such as D₁₀ of 1 to 7 μm, D₅₀ of 10 to 20 μm, and D₉₀ of 25 to 35 μm.

In the present invention, the silicon composite anode material may be a mixture of a first silicon composite anode material and a second silicon composite anode material.

In the present invention, in the first silicon composite anode material, D₁₀ may be 1 to 3 μm, D₅₀ may be 2 to 4 μm, and D₉₀ may be 3 to 5 μm.

In the present invention, in the second silicon composite anode material, D₁₀ may be 5 to 7 μm, D₅₀ may be 13 to 15 μm, and D₉₀ may be 30 to 35 μm.

In the present invention, the silicon composite may be a mixture of the first silicon composite anode material and the second silicon composite anode material at a ratio of 1:0.5 to 1:1.5, preferably 1:1. When the silicon composite anode materials are mixed at a mixing ratio other than the range described above, the packing density may be decreased.

Method of Manufacturing a Silicon Composite Anode Material with Controlled Particle Size Distribution

The present invention relates to a method of manufacturing a silicon composite anode material with controlled particle size distribution.

The present invention relates to a method of manufacturing a silicon composite anode material with controlled particle size distribution, and the method comprises the steps of: forming a graphite mixture by mixing graphite particles of different sizes; forming a silicon nanolayer by injecting silane (SiH₄) gas into the graphite mixture; and forming a carbon coating layer by injecting ethylene gas into the graphite layer on which the silicon nanolayer is formed.

Although the silicon layer crushed during the calendering process results in additional by-products and electrical contact loss in the silicon layer during cycling, morphological integrity of the silicon layer may be preserved during the calendering process through the method described above.

In the present invention, the step of forming a graphite mixture may be a process of mixing graphite particles having average particle sizes of 7 to 9 μm, 9 to 11 μm, 17 to 22 μm, and 28 to 32 μm at a mass ratio of 10:35 to 45:35 or 45:5 to 15, and preferably, mixing graphite particles having average particle sizes of 8 μm, 10 μm, 19 μm, and 30 μm at a mass ratio of 10:40:40:10.

In the present invention, the step of forming the silicon nanolayer may be a process of injecting silane gas at a speed of 30 to 70 sccm for 50 to 90 minutes at a temperature of 430 to 530° C., and preferably injecting the silane gas at a speed of 50 sccm for 60 minutes at a temperature of 480° C.

In the present invention, the step of forming a carbon coating layer may be a process of injecting ethylene gas at a speed of 80 to 120 sccm for 10 to 30 minutes at a temperature of 850 to 950° C.

In the present invention, the silicon composite anode material manufactured according to the manufacturing method may be a mixture of a first silicon composite anode material and a second silicon composite anode material.

In the present invention, in the first silicon composite anode material, D₁₀ may be 1 to 3 μm, D₅₀ may be 2 to 4 μm, and Do may be 3 to 5 μm.

In the present invention, in the second silicon composite anode material, D₁₀ may be 5 to 7 μm, D₅₀ may be 13 to 15 μm, and D₉₀ may be 30 to 35 μm.

Lithium-Ion Battery Containing a Silicon Composite Anode Material with Controlled Particle Size Distribution

The present invention relates to a lithium-ion battery containing a silicon composite anode material with controlled particle size distribution.

The lithium-ion battery containing a silicon composite anode material may exhibit excellent electrochemical performances such as high initial specific capacity and CE, low electrode expansion rate, excellent cyclability, and the like.

In the present invention, the lithium-ion battery may exhibit an initial specific capacity of 500 mAh/g or more and an initial coulombic efficiency of 92 to 98%.

In the present invention, the lithium-ion battery may exhibit an electrode expansion rate of 30 to 40% in the first cycle.

In the present invention, the lithium-ion battery may exhibit a capacity retention ratio of 95 to 99.5% for 50 cycles.

The present invention relates to an all-solid-state battery including the silicon composite anode material with controlled particle size distribution.

### EMBODIMENT

Hereinafter, although embodiments of the present invention will be described in detail, it is obvious that the present invention is not limited to the embodiments described below.

The advantages and features of the present invention and the method for achieving them, will become clear with reference to the embodiments described below in detail. However, the present invention is not limited to the embodiments disclosed below, but may be implemented in various different forms, and the embodiments are provided only to make the disclosure of the present invention complete and to fully inform those skilled in the art of the scope of the invention, and the present invention is defined only by the scope of the claims.

### <Embodiment 1> Silicon Composite Anode Material with Controlled Particle Size Distribution (WD-SiG)

Graphite having D₅₀ of 8, 10, 19, and 30 μm is mixed using a mixer at a mass ratio of 10:40:40:10. Thereafter, a uniform silicon nanolayer is formed on the surface of the graphite by injecting 99.99% high-purity silane gas into 50 g of the mixed graphite at 50 sccm for 1 hour at 480° C. using a rotary furnace. A silicon composite anode material with controlled particle size distribution on which carbon coating is completed (WD-SiG) is manufactured by performing carbon coating on the graphite, on which the nanolayer is formed, by injecting 99.99% high-purity ethylene gas at 100 sccm for 20 minutes at 900° C. using the rotary furnace.

### <Comparative Example 1> Silicon Composite Anode Material of the Same Particle Size (SIG)

A uniform silicon nanolayer is formed on the surface of the graphite by injecting high-purity silane gas into 50 g of graphite having D₅₀ of 11 μm at 50 sccm for 1 hour at 480° C. using a rotary furnace. A silicon composite anode material of the same particle size on which carbon coating is completed (SiG) is manufactured by performing carbon coating on the graphite, on which the nanolayer is formed, by injecting 99.99% high-purity ethylene gas at 100 sccm for 20 minutes at 900° C. using the rotary furnace.

### <Embodiment 2> WD-SiG Pellet Powder

The WD-SiG manufactured in embodiment 1 is mixed with SBR, CMC, and a conductive agent in a water solvent. A fine powder for pellets is manufactured by drying and sieving the slurry manufactured through the mixing, and a pellet powder is manufactured by adding a binder to make in a good shape without a crack and to have properties similar to those of an electrode.

### <Comparative Example 2> SiG Pellet Powder

The SiG manufactured in comparative example 1 is mixed with SBR, CMC, and a conductive agent in a water solvent. A fine powder for pellets is manufactured by drying and sieving the slurry manufactured through the mixing, and a pellet powder is manufactured by adding a binder to make in a good shape without a crack and to have properties similar to those of an electrode.

### <Experimental Example 1> Analysis of WD-SIG Characteristics Based on Packing Simulation

### <Experimental Example 1-1> DEM Simulation on Packing Density According to Mixing Ratio of Particles

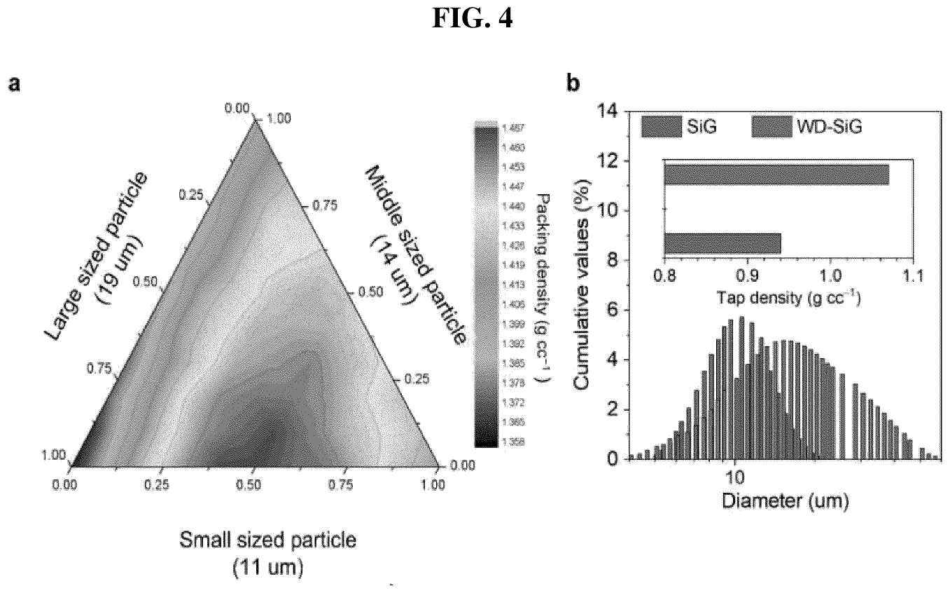

To confirm the optimized particle size distribution, a series of mixing and packing DEM simulations are performed on the packing density according to the mixing ratio of graphite of various sizes having D₅₀ particle sizes of 19 μm, 14 μm, and 11 μm based on particle size distribution (PSD) analysis, and a three-circle contour map of a packing density according to the mixing ratio shown as a result of the simulation is shown in FIG. 4(a).

As shown in FIG. 4(a), the high packing density in the contour map shown in the results of the DEM simulation shows a high tap density of powder that can be compressed at a relatively low pressure. Among all the results, the highest packing density is observed when 50% of large particles is mixed with 50% of small particles, and the lowest packing density is observed only in the large particles.

Through the result as described above, it is confirmed that a material having a high packing density, including graphite with a wide particle size distribution, can be manufactured by mixing graphite of various sizes according to the present invention.

### <Experimental Example 1-2> Statistical Analysis of Changes in Diameter

The particle size distributions of the silicon composite anode materials manufactured in embodiment 1 and comparative example 1 and tap density according thereto are measured, and a result thereof is shown in FIG. 4(b).

As shown in FIG. 4(b), the particle size distribution of the WD-SiG of embodiment 1 is wider than that of the SiG of comparative example 1. In addition, the tap density of the WD-SiG is 1.07 gcc⁻¹, and this is higher than tap density of 0.94 gcc⁻¹, which is the tap density of the SiG.

Through the result as described above, it is confirmed that the silicon composite anode material with controlled particle size distribution including a wide particle size distribution according to the present invention exhibits a high tap density.

### <Experimental Example 1-3> SEM Analysis

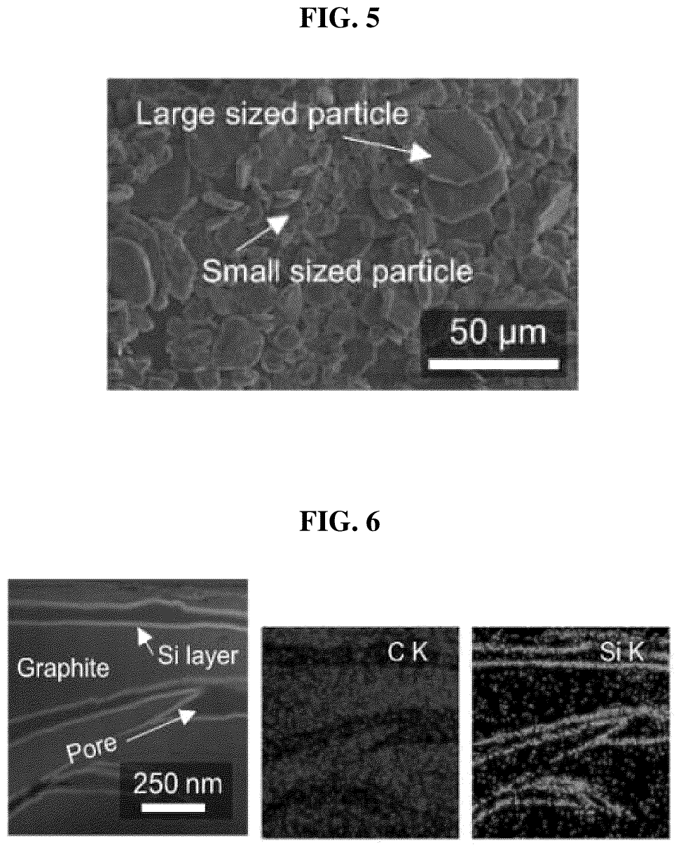

The particle-level shape of WD-SiG, i.e., a silicon composite anode material manufactured in embodiment 1, is analyzed using SEM, and a result thereof is shown in FIG. 5.

As shown in FIG. 5, in the WD-SiG, the particles of a size in a wide range of 4 to 50 μm are not broken and maintain their shape.

Through the result as described above, it is confirmed that the silicon composite anode material according to the present invention may mix particles of a size in a wide range while maintaining the shape.

### <Experimental Example 1-4> TEM and EDS Analysis

The cross-section of WD-SiG, i.e., a silicon composite anode material manufactured in embodiment 1, is analyzed using transmission electron microscopy (TEM) and energy dispersive spectroscopy (EDS), and a result thereof is shown in FIG. 6.

As shown in FIG. 6, it is confirmed that the WD-SiG is prepared by uniformly coating a thin silicon layer with a thickness of 15 nm on the surface of graphite.

Through the result as described above, it is confirmed that the silicon composite anode material according to the present invention may be prepared by uniformly coating a silicon layer on the surface of graphite.

### <Experimental Example 2> Analysis of Change in Stress of Particles During Electrode During Calendering Process

### <Experimental Example 2-1> Perform DEM Simulation on Particles in Electrode During Calendering Process

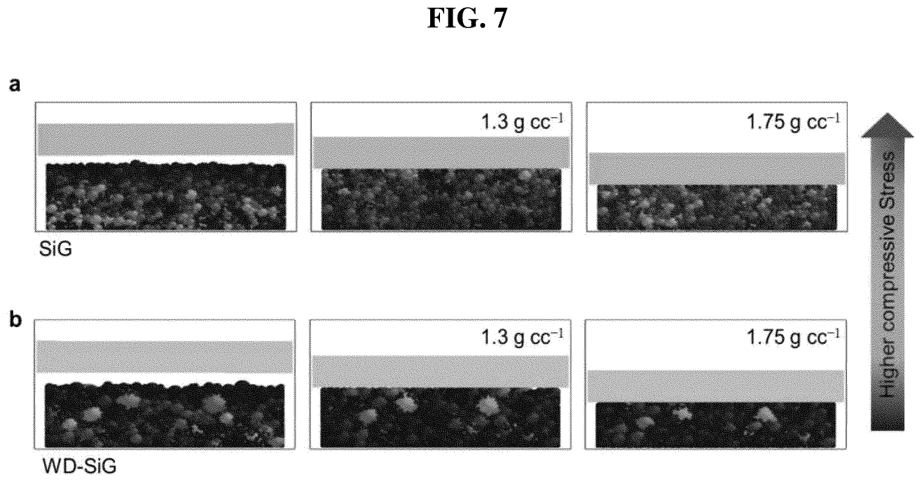

DEM simulation is performed to investigate efficiency from the aspect of stress change when an electrode including the silicon composite anode materials manufactured in embodiment 1 and comparative example 1 is applied with a pressure. Unlike an actual electrode for electrochemical analysis, it is assumed in the simulation that the electrode composition is configured of only an active material without a conductive material such as SBR or CMC or a binder, and pressure is applied until the density reaches 1.75 gcc⁻¹, and a result thereof is shown in FIG. 7.

As shown in FIG. 7, at an electrode density of 1.3 gcc⁻¹, a relatively low stress evolution occurs although the stress of all particles of the SiG of comparative example 1, especially those located on the pressed surface, is greatly intensified, and most of the particles maintain a normal state without stress in the WD-SiG electrode of embodiment 1.

Through the result as described above, it is confirmed that the silicon composite anode material according to the present invention exhibits stress relaxation of each particle even under a high-pressure condition due to wide size distribution.

### <Experimental Example 2-2> Perform DEM Simulation on Particles in Electrode According to Electrode Density During Calendering Process

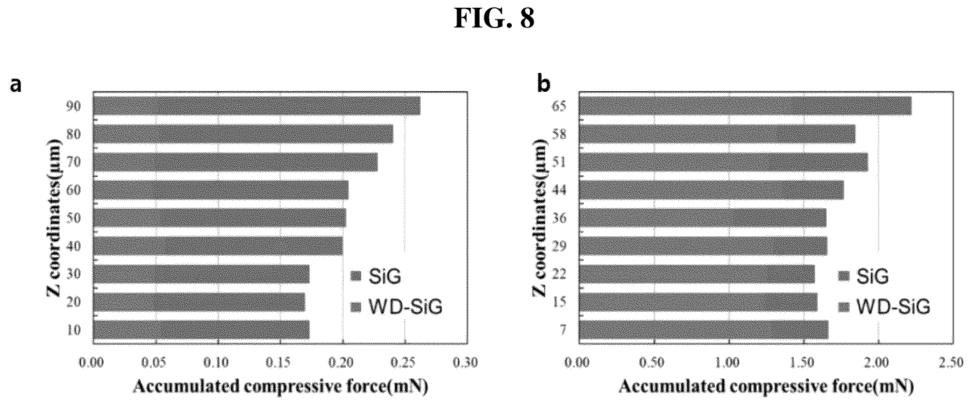

DEM simulation is performed by applying pressure until electrodes including the silicon composite anode materials manufactured in embodiment 1 and comparative example 1 reach electrode densities of 1.3 and 1.75 gcc⁻¹, respectively, to measure an accumulated compressive force, and a result thereof is shown in FIG. 8.

As shown in FIG. 8, the calculated compressive force applied to the particles of the SiG in comparative example 1 is about three times higher than the compressive force of the WD-SiG of embodiment 1 at an electrode density of 1.3 gcc⁻¹. In addition, even at an electrode density of 1.77 gcc⁻¹, the maximum compressive force of the SiG is 2.21 mN, which is higher than the maximum compressive force of 1.39 mN of the WD-SiG.

Through the result as described above, it is confirmed that as the silicon composite anode material according to the present invention exhibits a low compressive force in the calendering process, the structure of the silicon composite anode can be maintained.

### <Experimental Example 3> Measure Mechanical Stability of Cathode During Calendering Process

### <Experimental Example 3-1> Experiment on Pellet Density

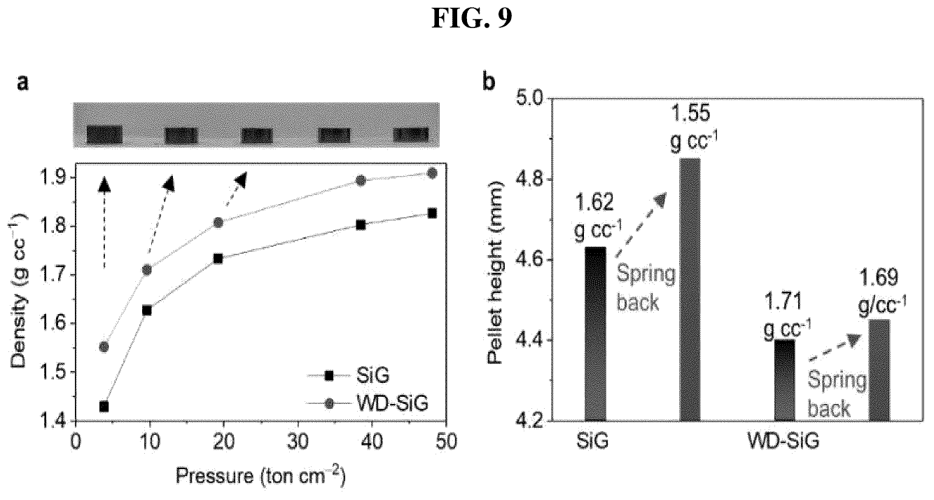

In order to determine whether changes in the stress occurring at different particle size distributions during the calendering process affect the shape and electrode state, pellet density is measured by pressing pellet powders containing the silicon composite anode materials manufactured in embodiment 2 and comparative example 2 through a pressing machine at various pressures of 3.8, 9.6, 19.2, 38.4, and 48.0 ton/cm², and a result thereof is shown in FIG. 9(a).

As shown in FIG. 9(a), pellets of the WD-SiG of embodiment 1 exhibit a density higher than that of the pellets of the SiG of comparative example 1 at the same pressure.

Through the result as described above, it is confirmed that the silicon composite anode material according to the present invention has a high packing density and almost no pressurization resistance.

In addition, a spring back test is performed by measuring the height after 6 hours of pressing the pellet powder containing the silicon composite anode materials manufactured in embodiment 2 and comparative example 2 at 9.6 ton/cm², and a result thereof is shown in FIG. 9(b).

As shown in FIG. 9(b), the height of the SiG pellet of comparative example 2 is increased to be higher than that of the WD-SiG pellet of embodiment 2.

Through the result as described above, it is confirmed that the silicon composite anode material according to the present invention has a low tendency of decrease in the high packing density.

### <Experimental Example 3-2> SEM Analysis after Calendering Process

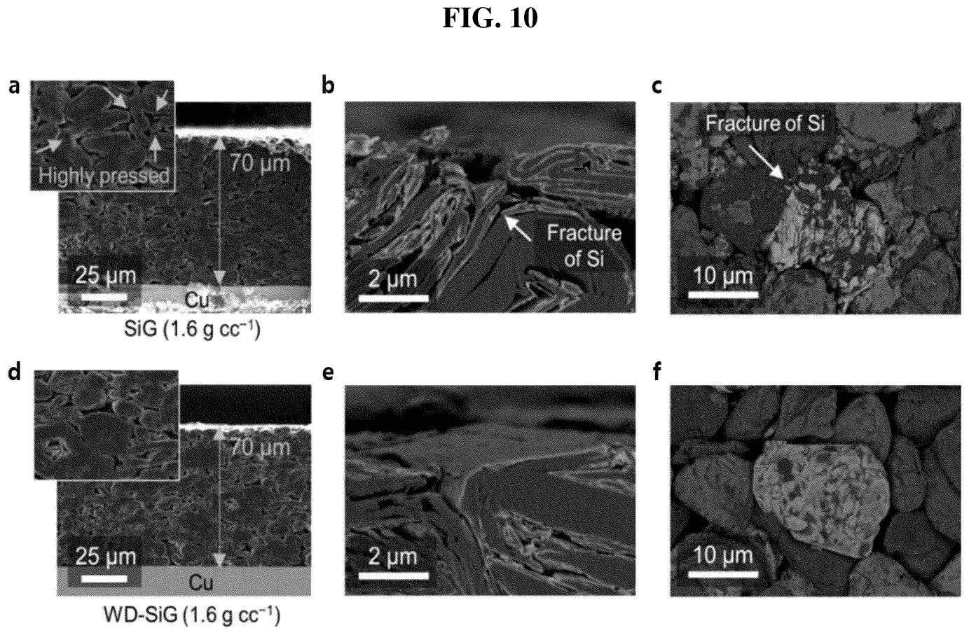

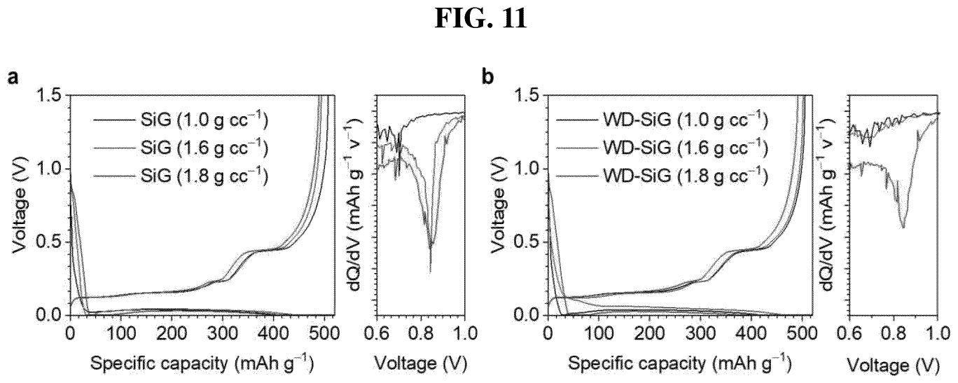

In order to investigate morphological changes at the particle level, pellet electrodes are manufactured with the same composition of the pellet powders containing the silicon composite anode materials manufactured in embodiment 2 and comparative example 2, and after performing a calendering process so that the electrode density became 1.6 gcc⁻¹, the pellet electrodes are analyzed using SEM, and a result thereof is shown in FIG. 10.

As shown in FIGS. 10(a) and (d), the cross-section of the SiG pellet electrode of comparative example 2 shows highly compressed particles, whereas the WD-SiG pellet electrode of embodiment 2 maintains a spherical shape even after the calendering process.

In addition, in the embodiment described above, it is analyzed using SEM of high magnification in the backscatter electron mode, and results thereof are shown in FIGS. 10(b), (c), (e), and (f).

As shown in FIGS. 10(b) and (c), the SiG pellet electrode of comparative example 2 shows cracks and breakage of the silicon and separation of the silicon layer from the graphite surface in the compressed particles.

However, as shown in FIGS. 10(b) and (e), it is confirmed in the WD-SiG pellet electrode of embodiment 2 that as the stress intensification of a wide particle size distribution is shown to be low during the calendering process, the silicon layer is firmly attached to the electrode, and as a morphological change does not occur, the structure is maintained at an electrode density of 1.6 gcc⁻¹.

Through the result as described above, it is confirmed that as the silicon composite anode material according to the present invention maintains its shape and structure even at a high electrode density, formation of by-products and electrical contact loss may be suppressed during lithiation.

### <Experimental Example 4> Analysis of Electrochemical Performance During Charging and Discharging

### <Experimental Example 4-1> Measurement of Voltage Profile and Volume Per Unit Voltage During Charging and Discharging

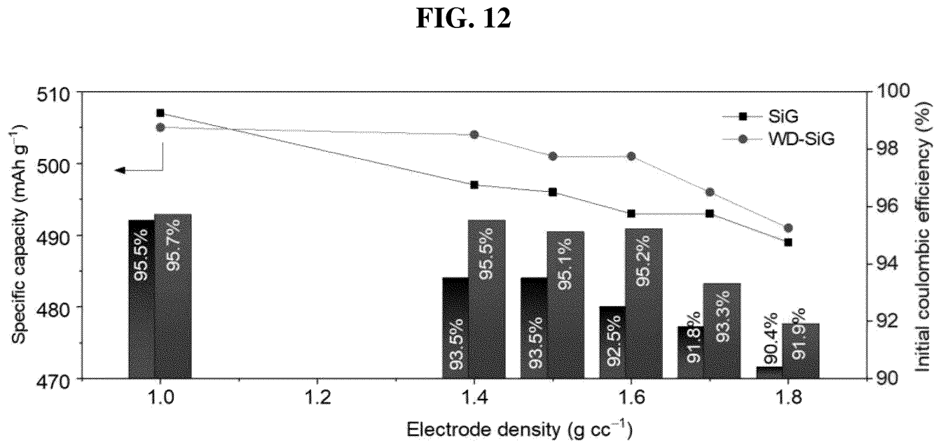

The initial specific capacities and CE of the electrodes including the silicon composites manufactured in embodiment 1 and comparative example 1 are investigated at electric densities of 1.0, 1.6, and 1.8 gcc⁻¹, and the differential capacity (dQ/dV) plots that characterize lithiation of each anode are measured during its first cycle, and a result thereof is shown in FIG. 12.

As shown in FIG. 12, both the SiG electrode and the WD-SiG electrode of comparative example 1 and comparative example 1 show a specific capacity of 507 mAh/g and a CE of 95% at an electrode density of 1.0 gcc⁻¹, whereas a difference in the specific capacity of 489 mAh/g and CE of 90.4% is observed at 1.8 gcc⁻¹.

In addition, the plot of the SiG electrode at the electrode densities of 1.6 and 1.8 gcc⁻¹ shows a peak assigned to 0.85 V, and therefore, it is confirmed that an SEI layer is formed through decomposition of electrolyte.

On the contrary, in the case of the WD-SiG of embodiment 1, the peak assigned to 0.85 V does not appear until the electrode density became 1.6 gcc⁻¹.

Through the result as described above, it is confirmed that the silicon composite anode material according to the present invention does not form an SEI layer by preventing the silicon surface not to be exposed to the electrolyte due to crushing and peeling of the silicon layer during the calendering process. In addition, it is confirmed that this prevents decrease in the initial CE and initial specific capacity.

### <Experimental Example 4-2> Measurement of Discharge Specific Capacity and Initial CE According to Electrode Density

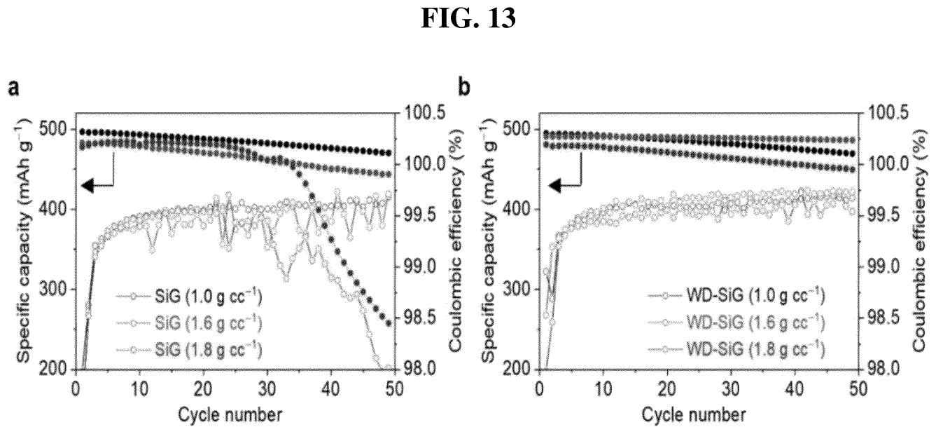

The initial specific capacity and CE of the electrodes including the silicon composites manufactured in embodiment 1 and comparative example 1 according to the electrode density in a range of 1.0 to 1.8 gcc⁻¹ are measured, and a result thereof is shown in FIG. 13.

As shown in FIG. 13, although the initial specific capacity and CE of the SiG electrode of comparative example 1 gradually decrease as the electrode density increases, the WD-SiG electrode of embodiment 1 maintains the initial specific capacity and CE relatively high as much as 1.6 gcc⁻¹, which is applied to the industry standard electrochemical evaluation condition.

Through the result as described above, it is confirmed that as the silicon composite anode material according to the present invention preserves high initial specific capacity and CE, industrially applicable performance is shown.

### <Experimental Example 5> Analysis of Electrochemical Characteristics

### <Experimental Example 5-1> Measurement of Reversible Capacity and Cycling Performance

The reversible capacity and cycling performance of half cells including the silicon composite anode materials manufactured in embodiment 1 and comparative example 1 are measured in a potential range of 0.005 to 1.0 V for 50 cycles at various electrode densities, and a result thereof is shown in FIG. 13.

As shown in FIG. 13(a), the SiG half-cell of comparative example 1 shows the best capacity retention at an electrode density of 1.0 gcc⁻¹. This indicates that a damaged silicon layer leads to the formation of an unstable SEI during cycling, and the damage is getting worse as the electrode density increases.

On the contrary, as shown in FIG. 13(b), the WD-SiG half-cell of embodiment 1 shows the best capacity retention at an electrode density of 1.6 gcc⁻¹.

Through the result as described above, it is confirmed that a battery including a silicon composite anode material according to the present invention exhibits a high-capacity retention ratio and cyclability as a crack does not occur in the silicon layer and electrical contact between particles increases after the calendering process.

### <Experimental Example 5-2> Measurement of Electrode Expansion Rate at Various Electrode Densities

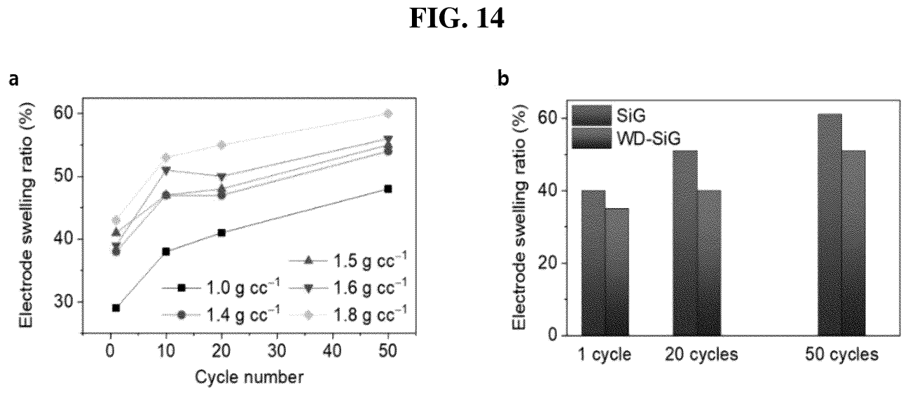

The expansion rate of half-cells including the silicon composite anode materials manufactured in embodiment 1 and comparative example 1 at electrode densities in a range of 1.0 to 1.8 gcc⁻¹ is measured, and a result thereof is shown in FIG. 14.

As shown in FIG. 14(a), the WD-SiG electrode of embodiment 1 shows that electrode expansion rate increases as the electrode density increases and the cycle is continued.

As shown in FIG. 14(b), it is confirmed that the electrode expansion rate of the WD-SiG electrode is lower than that of the SiG electrode of comparative example 1.

Through the result as described above, in the battery including the silicon composite anode material according to the present invention, it is confirmed that at a high electrode density where empty space is minimized due to the particles densely packed within the electrode, the electrode expansion rate increases due to expansion of silicon in the lithiation process, but the electrode expansion rate is low as it does not show highly compressed particles having a nonporous structure and unstable SEI formation resulting from a damaged silicon layer.

### <Experimental Example 5-3> Measurement of Capacity Retention Performance

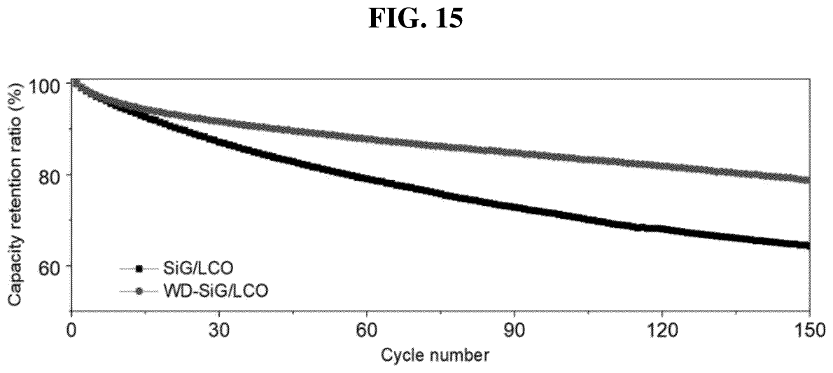

The discharge capacity of a pouch-type full cell including a negative electrode having the silicon composite anode materials manufactured in embodiment 1 and comparative example 1 and a lithium cobalt oxide positive electrode (LC) is measured for 150 cycles in a potential range of 2.7 to 4.2 V and a discharge rate of 1 C, and a result thereof is shown in FIG. 15.

As shown in FIG. 15, at an electrode density of 1.6 gcc⁻¹, the WD-SiG/LCO of embodiment 1 exhibits superior capacity retention compared to the SiG/LCO of comparative example 1.

Through the result as described above, it is confirmed that a battery including a silicon composite anode material according to the present invention exhibits a high-capacity retention ratio.

1. A silicon composite anode material with controlled particle size distribution, the material comprising:
a graphite mixture;
a silicon nanolayer coated on the graphite mixture; and
a carbon coating layer coated on the silicon nanolayer, wherein
the silicon composite anode material has a multi-size distribution.

2. The silicon composite anode material according to claim 1, wherein the silicon nanolayer contains particles having a size of 2 nm to 2 μm.

3. The silicon composite anode material according to claim 1, wherein the silicon composite anode material contains pores having a size of 2 nm to 10 μm.

4. The silicon composite anode material according to claim 1, wherein the silicon composite anode material contains particles having a size of 0.5 to 50 μm.

5. The silicon composite anode material according to claim 1, wherein the silicon composite anode material has particle size distributions such as D₁₀ of 1 to 7 μm, D₅₀ of 10 to 20 μm, and D₉₀ of 25 to 35 μm.

6. The silicon composite anode material according to claim 1, wherein the silicon composite anode material is a mixture of a first silicon composite anode material and a second silicon composite anode material.

7. The silicon composite anode material according to claim 6, wherein in the first silicon composite anode material, D₁₀ is 1 to 3 μm, D₅₀ is 2 to 4 μm, and D₉₀ is 3 to 5 μm.

8. The silicon composite anode material according to claim 6, wherein in the second silicon composite anode material, D₁₀ is 5 to 7 μm, D₅₀ is 13 to 15 μm, and D₉₀ is 30 to 35 μm.

9. The silicon composite anode material according to claim 6, wherein the silicon composite is a mixture of the first silicon composite material and the second silicon composite material at a ratio of 1:0.5 to 1:1.5.

10. A method of manufacturing a silicon composite anode material with controlled particle size distribution, the method comprising the steps of:
forming a graphite mixture by mixing graphite particles of different sizes;
forming a silicon nanolayer by injecting silane (SiH₄) gas into the graphite mixture; and
forming a carbon coating layer by injecting ethylene gas into the graphite layer on which the silicon nanolayer is formed.

11. The method according to claim 10, wherein the step of forming a graphite mixture is a process of mixing graphite particles having average particle sizes of 7 to 9 μm, 9 to 11 μm, 17 to 22 μm, and 28 to 32 μm at a mass ratio of 10:35 to 45:35 or 45:5 to 15.

12. The method according to claim 10, wherein the step of forming the silicon nanolayer is a process of injecting silane gas at a speed of 30 to 70 sccm for 50 to 90 minutes at a temperature of 430 to 530° C.

13. The method according to claim 10, wherein the step of forming a carbon coating layer is a process of injecting ethylene gas at a speed of 80 to 120 sccm for 10 to 30 minutes at a temperature of 850 to 950° C.

14. The method according to claim 10, wherein the silicon composite anode material manufactured according to the manufacturing method is a mixture of a first silicon composite anode material and a second silicon composite anode material.

15. The method according to claim 14, wherein in the first silicon composite anode material, D₁₀ is 1 to 3 μm, D₅₀ is 2 to 4 μm, and D₉₀ is 3 to 5 μm.

16. The method according to claim 14, wherein in the second silicon composite anode material, D₁₀ is 5 to 7 μm, D₅₀ is 13 to 15 μm, and D₉₀ is 30 to 35 μm.

17. A lithium-ion battery containing a silicon composite anode material according to claim 1.

18. The battery according to claim 17, wherein the lithium-ion battery exhibits an initial specific capacity of 500 mAh/g or more and an initial coulombic efficiency of 92 to 98%.
